(19) United States
(12) Patent Application Publication
(10) Pub. No.: US 2008/0311264 A1
(43) Pub. Date: Dec. 18, 2008

(54) Grill plate

(75) Inventors: Timothy Paul Tippmann, Fort Wayne, IN (US); Barry Lawrence Tippmann, Fort Wayne, IN (US)

Correspondence Address: BIRCH STEWART KOLASCH & BIRCH, PO BOX 747, FALLS CHURCH, VA, 22040-0747, US

(73) Assignee: THERMODYNE FOODSERVICE PRODUCTS, INC., Fort Wayne, IN (US)

(21) Appl. No.: 12/073,566

(22) Filed: Mar. 6, 2008

Related U.S. Application Data
(60) Provisional application No. 60/905,802, filed on Mar. 9, 2007.

(51) Int. Cl. A47J 37/06; A23L 1/01

(52) U.S. Cl. 426/523; 99/446; 99/444

(57) ABSTRACT

A grill plate includes a plurality of bars having a predetermined width, thickness and length that are arranged substantially parallel relative to each other with adjacent bars being secured relative to each other. A predetermined narrow spacing is provided between adjacent bars. The plurality of bars provide a substantially flat surface formed by the predetermined width of the plurality of bars secured adjacent to each other and the predetermined narrow spacing therebetween. The substantially flat surface enables a food product to be cooked thereon with the predetermined space permitting a draining of any residue from the food product as the food product is cooked.

### PRIORITY CLAIM

The present application claims priority to U.S. Provisional Patent Application No. 60/905,802, filed on Mar. 9, 2007.

### BACKGROUND OF THE INVENTION

1. Field of the Invention

The present invention relates to a grill plate wherein a plurality of bars or plates are secured together with a predetermined space being provided between adjacent bars with the width of each bar or plate forming a surface upon which a food product may be cooked.

2. Description of Background Art

Heretofore, a griddle for cooking a food product required a flat metal surface with a heat source being supplied below the flat metal surface. A food product is positioned on the griddle and the food is cooked. However, the food product normally includes a quantity of water or fat that is released from the food product as the food product is heated. The water will be disposed on the flat metal surface of the griddle and is boiled off as the food product is cooked. The boiling off of the water reduces the heat available for cooking the food product which results in an increase in the amount of time necessary for cooking the food product on the griddle.

### SUMMARY AND OBJECTS OF THE INVENTION

It is an object of an embodiment of the present invention, to provide a grill plate wherein a plurality of bars are secured together with a predetermined space being provided between adjacent bars. The width of each grill bar combined forms a surface upon which a food product may be cooked. As the food product is cooked, water, fat and other residue from the food product can be discharged through the space provided between adjacent bars so as to permit the food product to be cooked at a faster speed and with a better taste.

The objects of the present invention are achieved by providing a grill plate that includes a plurality of bars having a predetermined width, thickness and length. The plurality of bars are arranged substantially parallel relative to each other with adjacent bars being secured relative to each other. A predetermined narrow spacing is provided between adjacent bars. The plurality of bars provide a substantially flat surface formed by the predetermined width of the plurality of bars secured adjacent to each other and the predetermined narrow spacing therebetween. The substantially flat surface enables a food product to be cooked thereon with the predetermined space permitting draining of any residue from the food product as the food product is cooked.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective view of a grill plate according to the present invention;

FIG. 2 is a top plan view of the grill plate; and

FIG. 3 is a side elevational view of the grill plate.

### DETAILED DESCRIPTION OF THE PREFERRED EMBODIMENTS

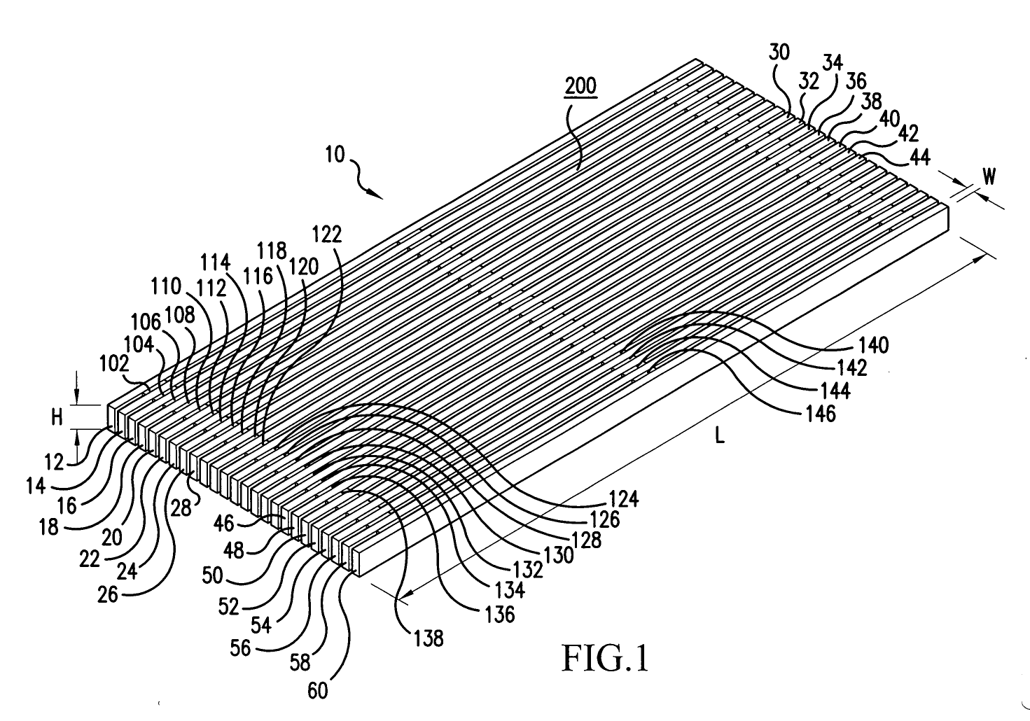

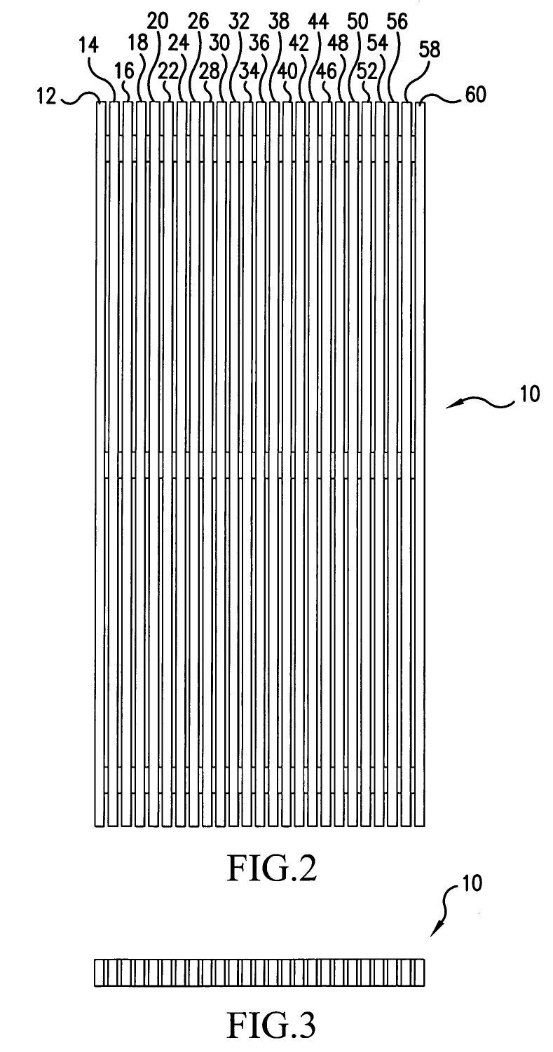

As illustrated in FIGS. 1-3, a grill plate 10 includes a plurality of bars 12, 14, 16, 18, 20, 22, 24, 26, 28, 30, 32, 34, 36, 38, 40, 42, 44, 46, 48, 50, 52, 54, 56, 58 and 60 having a predetermined width W, thickness or height H and length L. The plurality of bars are arranged to be substantially parallel relative to each other with adjacent bars being secured relative to each other. The bars may be considered plate members wherein the plate members have a width, thickness and length. The plate members are arranged to be substantially parallel relative to each other with adjacent plates being secured relative to each other to form the grill plate 10. Hereinafter the description of the invention will refer to bars that are considered to have a width, thickness and length to form the grill plate 10.

In one embodiment of the present invention, the adjacent bars may be directly welded to each other with the predetermined narrow space being formed therebetween. In another embodiment of the present invention, a plurality of spacers 102, 104, 106, 108, 120, 122, 124, 126, 128, 130, 132, 134, 136, 138, 140, 142, 144 and 146 are provided to ensure that a predetermined space is formed between the plurality of bars. The plurality of spacers may be positioned adjacent to both ends of the plurality of bars and at a central location for spacing the plurality of bars.

The plurality of bars 12, 14, 16, 18, 20, 22, 24, 26, 28, 30, 32, 34, 36, 38, 40, 42, 44, 46, 48, 50, 52, 54, 56, 58 and 60 provide a substantially flat surface 200 formed by the predetermined width W of the plurality of bars secured adjacent to each other with a predetermined narrow spacing therebetween. The substantially flat surface 200 enables a food product to be cooked thereon with the predetermined space permitting draining of any residue from the food product as the food product is cooked.

According to an embodiment of the present the plurality of bars 12, 14, 16, 18, 20, 22, 24, 26, 28, 30, 32, 34, 36, 38, 40, 42, 44, 46, 48, 50, 52, 54, 56, 58 and 60 provide a heat sink for maintaining a steady supply of heat supplied to the grill plate. In addition, the predetermined narrow spacing between adjacent bars prevents heat from the heat source from immediately being supplied therethrough so that the food product is cooked evenly and quickly.

In addition, in view of the narrow space being formed between the plurality of bars 12, 14, 16, 18, 20, 22, 24, 26, 28, 30, 32, 34, 36, 38, 40, 42, 44, 46, 48, 50, 52, 54, 56, 58 and 60 it is possible to cook a variety of food products including smaller items such as vegetables, namely, onions, beans, celery, peppers and a variety of other vegetables without the vegetables falling through the narrow spacing between adjacent bars.

Further, the substantially flat surface 200 formed by the width of the plurality of bar members enables a spatula to be used for handling the food product in the same manner that a spatula is currently used with regard to a griddle.

The grill 10 may be used in a conventional restaurant as the grill for cooking food products to replace a conventional flat metal plate or griddle. In addition, the grill 10 may be used on a commercial or home barbecue for cooking a food product over a propane, natural gas or charcoal fire.

In an embodiment of the present invention, it is anticipated that each of the plurality of bars would be 0.75 inches (1.905 cm) in height, 0.25 inches (0.635 cm) in width and any length depending on the application. The spacing may be 0.125 inches (0.3175 cm) or any other suitable spacing to permit the food products to be quickly and more evenly cooked to taste better.

An embodiment of the present invention is directed to the method of cooking a food product wherein a user would start by providing a plurality of bars 12, 14, 16, 18, 20, 22, 24, 26, 28, 30, 32, 34, 36, 38, 40, 42, 44, 46, 48, 50, 52, 54, 56, 58 and 60 having a predetermined width, thickness and length and by arranging the plurality of bars to be substantially parallel relative to each other with adjacent bars being secured relative to each other and by providing a predetermined narrow spacing between adjacent bars. The cooking of a food product occurs on a top surface of the plurality of bars formed by the predetermined width of the plurality of bars secured adjacent to each other and the predetermined narrow spacing therebetween. Draining of any residue from the food product through the predetermined narrow spacing occurs as a food product is cooked thereon. The method of cooking of the present invention produces a food product that cooks faster, taste better and is more evenly cooked.

The grill plate 10 of the present invention conserves energy by forcing the heat to travel upwardly between the spacing in adjacent bars to heat the bars more evenly in view of the fact that the heat does not immediately escape upwardly as occurs with respect to a conventional grill plate. Thus, by using the grill plate 10 of the present invention with a conventional barbecue grill an individual is able to conserve propane or gas or charcoal that is supplied to a barbecue grill. Less propane or gas or charcoal is needed to heat the grill plate 10 for cooking the food product in view of the fact that the heat does not go through the space between the bars so quickly.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A grill plate comprising:
a plurality of bars having a predetermined width, thickness and length and being arranged substantially parallel relative to each other with adjacent bars being secured relative to each other; and
a predetermined narrow spacing being provided between adjacent bars;
wherein the plurality of bars provide a substantially flat surface formed by the predetermined width of the plurality of bars secured adjacent to each other and the predetermined narrow spacing therebetween, said substantially flat surface enables a food product to be cooked thereon with the predetermined space permitting a draining of any residue from the food product as the food product is cooked.

2. The grill plate according to claim 1, wherein said plurality of bars provide a heat sink for retaining heat supplied to the grill plate.

3. The grill plate according to claim 1, wherein the predetermined narrow spacing between adjacent bars prevents heat from a heat source from immediately passing therethrough.

4. The grill plate according to claim 1, wherein the substantially flat surface enables a spatula to be used for handling the food product.

5. The grill plate according to claim 1, wherein the substantially flat surface with the predetermined narrow spacing being formed between adjacent bars enables relative small food products to be cooked thereon without the relatively small food products falling between the adjacent bars.

6. The grill plate according to claim 1, wherein the substantially flat surface with the predetermined narrow spacing being formed between adjacent bars enables a food product to be cooked evenly and quickly thereon.

7. A grill plate comprising:
a plurality of bars having a predetermined width, thickness and length and being arranged substantially parallel relative to each other with adjacent bars being secured relative to each other; and
spacers provided between each of the plurality of bars for forming a predetermined narrow spacing between adjacent bars;
wherein the plurality of bars provide a substantially flat surface formed by the predetermined width of the plurality of bars secured adjacent to each other and the spacers forming the predetermined narrow spacing therebetween, said substantially flat surface enables a food product to be cooked thereon with the predetermined space permitting a draining of any residue from the food product as the food product is cooked.

8. The grill plate according to claim 7, wherein said plurality of bars provide a heat sink for retaining heat supplied to the grill plate.

9. The grill plate according to claim 7, wherein the predetermined narrow spacing between adjacent bars prevents heat from a heat source from immediately passing therethrough.

10. The grill plate according to claim 7, wherein the substantially flat surface enables a spatula to be used for handling the food product.

11. The grill plate according to claim 7, wherein the substantially flat surface with the predetermined narrow spacing being formed between adjacent bars enables relative small food products to be cooked thereon without the relatively small food products falling between the adjacent bars.

12. The grill plate according to claim 7, wherein the substantially flat surface with the predetermined narrow spacing being formed between adjacent bars enables a food product to be cooked evenly and quickly thereon.

13. A method of cooking a food product comprising the following steps:
providing a plurality of bars having a predetermined width, thickness and length;
arranging the plurality of bars to be substantially parallel relative to each other with adjacent bars being secured relative to each other;
providing a predetermined narrow spacing between adjacent bars;
cooking a food product on a top surface of the plurality of bars formed by the predetermined width of the plurality of bars secured adjacent to each other and the predetermined narrow spacing therebetween; and
permitting draining of any residue from the food product through the predetermined narrow spacing as a food product is cooked thereon.

14. The method according to claim 13, wherein said plurality of bars providing a heat sink for retaining heat supplied to the grill plate.

15. The method according to claim 13, wherein the predetermined narrow spacing between adjacent bars prevents heat from a heat source from immediately passing therethrough.

16. The method according to claim 13, wherein the substantially flat surface enables a spatula to be used for handling the food product.

17. The method according to claim 13, wherein the substantially flat surface with the predetermined narrow spacing being formed between adjacent bars enables relative small food products to be cooked thereon without the relatively small food products falling between the adjacent bars.

18. The method according to claim 13, wherein the substantially flat surface with the predetermined narrow spacing being formed between adjacent bars enables a food product to be cooked evenly and quickly thereon.
